(19) United States
(12) Patent Application Publication
(10) Pub. No.: US 2011/0134470 A1
(43) Pub. Date: Jun. 9, 2011

(54) INFORMATION PROCESSING APPARATUS, DISPLAY CONTROL METHOD, AND STORAGE MEDIUM

(75) Inventor: Yosui Naito, Kawasaki-shi (JP)

(73) Assignee: CANON KABUSHIKI KAISHA, Tokyo (JP)

(21) Appl. No.: 12/941,856

(22) Filed: Nov. 8, 2010

(30) Foreign Application Priority Data
Dec. 7, 2009 (JP) 2009-278008

(51) Int. Cl. G06F 3/12

(52) U.S. Cl. 358/1.15

(57) ABSTRACT

The information processing apparatus which controls a display unit includes a control unit configured to control the display unit to display specific information in area which is different from an area of image in which the specific information is included or configured to control the display unit to display specific information in an area determined according to a position where a user's input operation is detected.

### BACKGROUND OF THE INVENTION

1. Field of the Invention

The present invention generally relates to information processing and, more particularly, to an information processing apparatus, a display control method, and a storage medium.

2. Description of the Related Art

When an official document which includes personal information, such as name and address is previewed on an apparatus or the like, if a user displays the information without taking certain precautions, there is a fear that the personal information is looked by others. As a method for displaying such specific information (hereinafter referred to as confidential information that should be concealed from viewing by others), Japanese Patent Application Laid-Open No. 2008-113355 describes an apparatus which uses two large and small, display units.

In this apparatus, in an ordinary preview in which an image represented by image data is displayed, a large display unit is used to display the image. When the image data includes confidential information, the large display unit displays the image at low resolution, and a small display unit is used to display an image in an area selected from of the image on the large display unit at high resolution.

In a case where only a single display unit is available, if the confidential information is displayed together with other pieces of information, it is highly possible that the confidential information is viewed by someone else.

Therefore, it is important to make confidential information difficult to be viewed when the confidential information and other information are displayed on a single display unit.

### SUMMARY OF THE INVENTION

According to an aspect of the present invention, an information processing apparatus which controls a display unit, includes a control unit configured to control the display unit to display specific information in area which is different from an area of image in which the specific information is included or configured to control the display unit to display specific information in an area determined according to a position where a user's input operation is detected.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of an information processing apparatus to which the present invention can be applied.

FIG. 2 illustrates an example of a preview screen according to an exemplary embodiment of the present invention.

FIG. 3 illustrates an example of a window for displaying confidential information according to an exemplary embodiment of the present invention.

FIG. 4 illustrates an example of a confidential information display area when a user puts his/hers hand on an operation unit according to an exemplary embodiment of the present invention.

FIGS. 5A and 5B are conceptual diagrams illustrating a relation between connecting points of a part where a hand contacts and a position of the confidential information display area according to an exemplary embodiment of the present invention.

FIGS. 6A and 6B illustrates a method for calculating a position and a size of the confidential information display area in relation to connecting points of the part where the hand contacts according to an exemplary embodiment of the present invention.

FIG. 7 is a flowchart illustrating preview processing according to an exemplary embodiment of the present invention.

### DESCRIPTION OF THE EMBODIMENTS

Various exemplary embodiments, features, and aspects of the invention will be described in detail below with reference to the drawings.

In recent years, multifunction peripherals (MFPs) with printing and scanning functions have been installed in convenience stores and supermarkets. Since there are many such sales outlets and they are often open twenty-four hours a day, they provide an environment in which a user can easily use an MFP. In the future, an official document, such as a certificate of residence, might be able to be printed on such an MFP.

However, official documents typically include personal information, such as a user's name and address. When image data of an official document is displayed as it is for preview for the user to check the information on the document before it is printed, the user may have a fear that specific information including the personal information may be looked by others.

A display control method for displaying specific information in a manner which is difficult for others to see will be described below in accordance with the present invention. Image data to be displayed is not limited to official documents. Image data including specific information such as confidential information to be kept confidential can be handled in the method. The specific information may include not only personal information but also any pieces of confidential information that a user wants to hide. Display of an image represented by image data is not limited to when the image data is printed, but may be whenever the user wants to check the image represented by the image data.

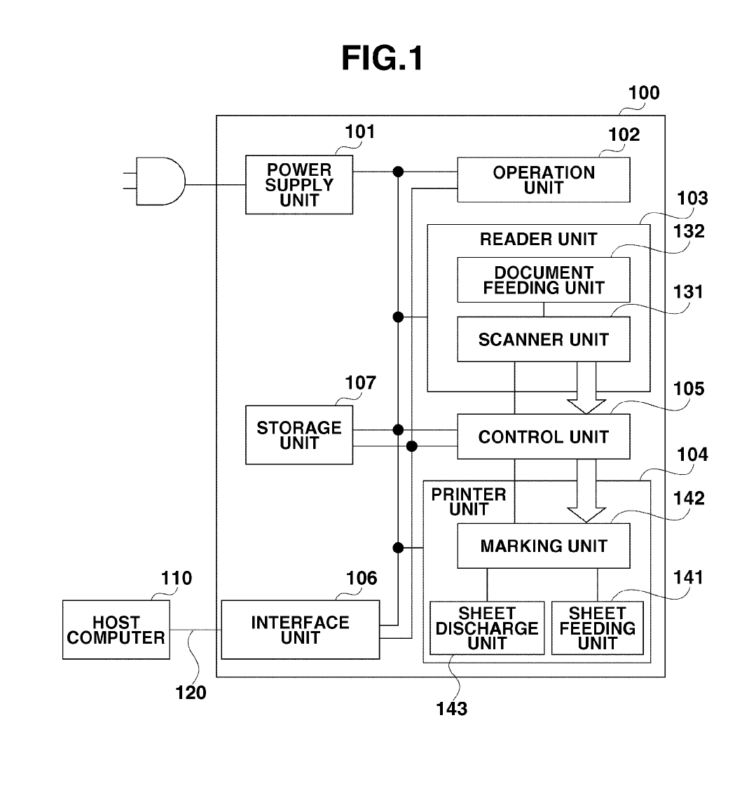

FIG. 1 is a block diagram illustrating a configuration of an information processing apparatus to which the present invention can be applied. An information processing apparatus 100 includes a power supply unit 101, an operation unit (operation panel) 102, a reader unit 103, a printer unit 104, a control unit 105, an interface unit 106, and storage unit 107.

The power supply unit 101 receives power supply from outside, and supplies electric power to the operation unit 102, the reader unit 103, the printer unit 104, the control unit 105, the interface unit 106, and the storage unit 107. The operation unit 102 which includes a display unit and a plurality of operation keys, displays many pieces of information, and receives various commands from a user.

The reader unit 103 optically reads an image on a document, and converts the image into image data. The reader unit 103 includes a scanner unit 131 configured to read an image on a document and a document feeding unit 132 configured to convey the document.

The printer unit 104 includes a sheet feeding unit 141, a marking unit 142, and a sheet discharge unit 143. The printer unit 104 conveys a recording sheet, prints image data in a visible image on the recording sheet, and discharges the printed sheet to the outside of the apparatus. The sheet feeding unit 142 includes recording sheet cassettes which can store different types of the recording sheets. The marking unit 142 transfers the visible image of by the image data to the recording sheet, and fixes the image to the recording sheet. The sheet discharge unit 143 sorts or staples printed recording sheets, and outputs them to the outside of the apparatus.

The control unit 105 is electrically connected to the operation unit 102, the reader unit 103, the printer unit 104, the interface unit 106, and the storage unit 107, and controls those units comprehensively. The control unit 105 is connected to an external network 120 via the interface unit 106 and communicates with an external apparatus, such as a host computer 110 via the network 120.

When the information processing apparatus 100 includes a copying function, the control unit 105 controls the reader unit 103 to input image data, and controls the printer unit 104 to print out an image based on the image data. When the information processing apparatus 100 includes a scanning function, the control unit 105 controls the reader unit 103 to input image data, converts the image data into coded data, and transfers the coded data to the external apparatus, such as the host computer 110 via the interface unit 106 and the network 120. When the information processing apparatus 100 includes a printing function, the control unit 105 receives coded data from the external apparatus, such as the host computer 110, converts the coded data into image data, and controls the printer unit 104 to print an image based on the image data.

The control unit 105 can control the storage unit 107 to store image data generated by the reader unit 103 or image data received from the external apparatus. Further, the control unit 105 causes the printer unit 104 to print image data selected by a user from pieces of the image data stored in the storage unit 107 or sends the image data to the external apparatus. The storage unit 107 may include a storage medium, such as a random access memory (RAM) or a hard disk.

In addition to the host computer 110, the external apparatus may include, for example, a personal computer, a server computer, and another information processing apparatus which includes a reader unit and a printer unit, as in the information processing apparatus 100.

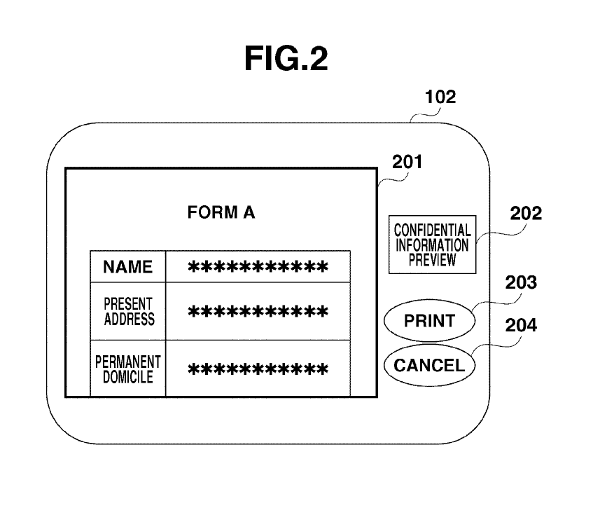

FIG. 2 illustrates an example of a preview screen according to an exemplary embodiment of the present invention. In FIG. 2, the operation unit 102 includes a liquid crystal display unit 201, and operation keys 202 through 204. The liquid crystal display unit 201 displays an operation screen for a user to operate the information processing apparatus 100, a screen to indicate a state of the information processing apparatus 100, a preview screen to preview image data, and the like. Since the liquid crystal display unit 201 includes a touch panel, when the user touches the liquid crystal display unit 201, a position of a user's hand can be detected. Therefore, the user's input operation can be detected via the liquid crystal display unit 201.

A confidential information preview button 202 is used when the user instructs display of the preview screen for display a preview of confidential information which is described below. A print button 203 is used when the user instructs printing. A cancel button 204 is used by the user to cancel operations that have been made.

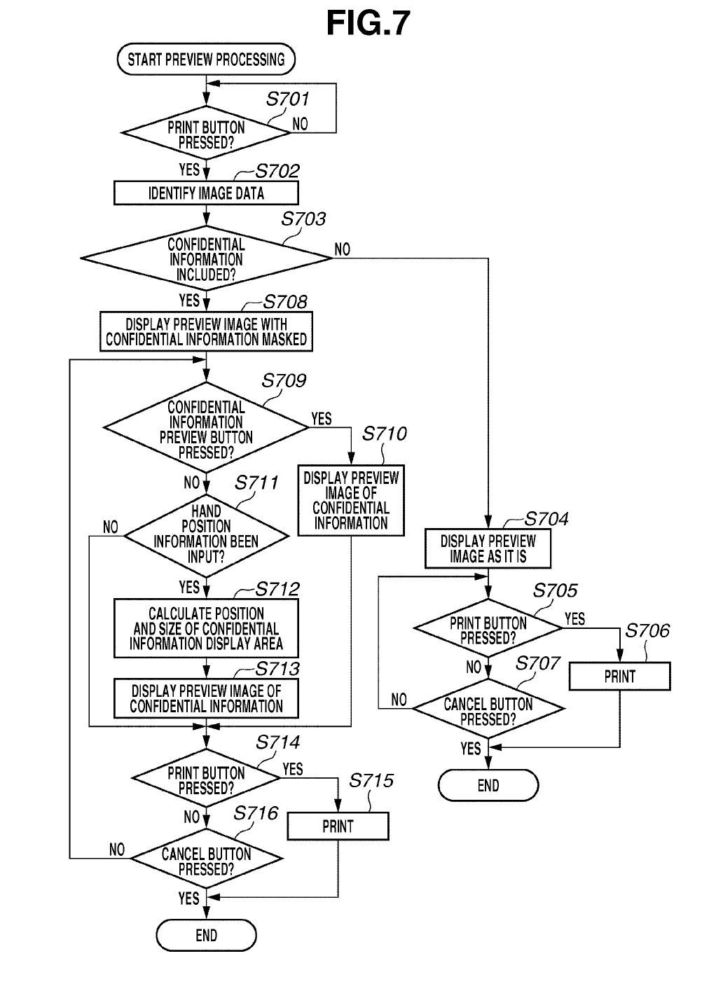

Preview processing according to the exemplary embodiment of the present invention will be described. FIG. 7 is a flowchart of the preview processing. The preview processing is performed by a central processing unit (CPU) of the control unit 105 executing a program stored in a read-only memory (ROM) in the control unit 105.

A user selects image data that the user wants to print on a screen displayed on the liquid crystal display unit 201, and then presses the print button 203. The user can select the image data to be printed from pieces of the image data which are generated by the reader unit 103 or received from the external apparatus via the network 120 and stored in the storage unit 107.

In step S701, the control unit 105 determines whether the print button 203 is pressed. When the control unit 105 detects that the print button 203 is pressed, the processing proceeds to step S702. In step S702, the control unit 105 identifies image data selected by the user.

In step S703, the control unit 105 determines whether confidential information is included in the image data specified in step S702. A method used for the determination is to refer to a flag which is added to the image data and indicates whether confidential information is included. Another method is to analyze the image data to determine whether confidential information is included. Further, another method is to determine whether an image represented by the image data corresponds to any of a plurality of template documents that may be available.

A portion including the confidential information in the image represented by the image data may be identified according to position information added to the image data or may be identified from a result of analysis of the image data.

As a method for determining information to be handled as the confidential information, a type of information to be kept confidential may be specified in advance, and information included in the specified type may be determined as the confidential information. Or, a portion that corresponds to confidential information in an image represented by the image data may be designated in advance, and information indicating the portion which is confidential may be added to the image data. Further, a portion that corresponds to confidential information may be designated in each of a plurality of template documents, and then the portion of the confidential information may be identified by checking the image represented by the image data with the template documents.

If the image is determined not to include the confidential information (NO in step S703), the processing proceeds to step S704. In step S704, the control unit 105 controls the operation unit 102 to display the image based on identified image data as it is on the liquid crystal display unit 201.

When the user checks the preview of the image data and decides again to print the image data, the user presses the print button 203 again. As a result of preview, if the user wants to cancel printing of the image data, the user presses the cancel button 204.

In step S705, the control unit 105 determines whether the print button 203 is pressed again. When the control unit 105 detects that the print button 203 is pressed again (YES in step S705), the processing proceeds to step S706. In step S706, the control unit 105 controls the printer unit 104 to perform printing based on the image data identified in step S702.

If the print button 203 is not pressed again (NO in step S707), then in step S707, the control unit 105 determines whether the cancel button 204 is pressed. If the control unit 105 detects that the cancel button 204 is pressed (YES in step S707), the preview processing is terminated.

In step S703, if it is determined that the image data includes the confidential information (YES in step S703), the processing advances to step S708. In step S708, the control unit 105 extracts the confidential information from the image data, and generates image data in which the portion of the confidential information is masked in the image represented by the image data. Then, the control unit 105 controls the operation unit 102 to display an image based on the image data on the liquid crystal display unit 201.

FIG. 2 illustrates a preview screen displayed in step S708. In FIG. 2, a name, a present address, and a permanent domicile as confidential information are replaced by a symbol “*”. Instead of replacement by the symbol “*”, the image may be processed to hide the content by use of another predetermined symbol, a predetermined alphanumeric character, and/or by blurring. Accordingly, although the confidential information itself is hidden, the user can confirm where the confidential information is included. Since information other than the confidential information can be displayed as it is, the user can confirm the information other than the confidential information.

In step S709, the control unit 105 determines whether the confidential information preview button 202 is pressed. If it is detected that the confidential information preview button 202 is pressed (YES in step S709), the processing advances to step S710. In step S710, the control unit 105 controls the operation unit 102 to display the confidential information extracted in step S708 on the liquid crystal screen 201.

Therefore, when the user makes sure that there is nobody around or takes a posture to hide the liquid crystal display unit 201 by the body or a hand, the user can press the confidential information preview button 202 to display the confidential information.

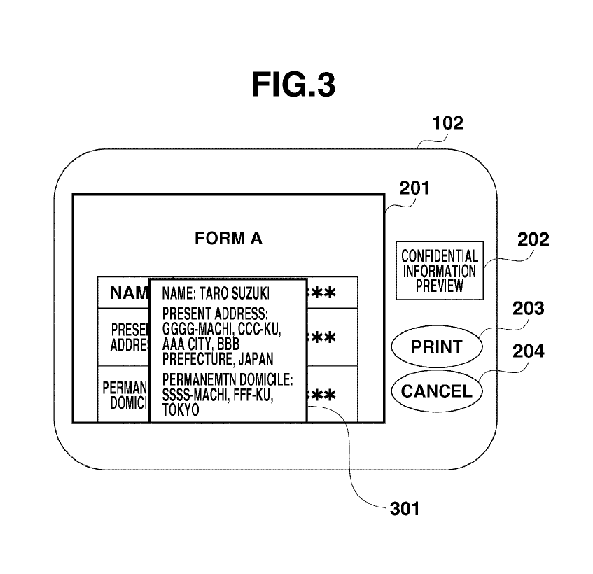

FIG. 3 illustrates an example of an area in which the confidential information is displayed. When the user presses the confidential information preview button 202, a confidential information display area 301 appears in a lower middle position of the liquid crystal display unit 201. When the confidential information preview button 202 is pressed, a position and a size of the confidential information display area 301 may be fixed.

Since almost every user operates the operation unit 102 standing in front thereof, if the confidential information display area 301 is placed at a position which cannot be viewed from a person standing behind the user, in other words, at a position completely hidden by the user's body, the information can be surely hidden from the others. Thus, it is difficult for another person to view the confidential information even if he/she tries to peep.

In step S711, the control unit 105 determines whether position information indicating a position of a hand is input. Since the liquid crystal display unit 201 includes the touch panel, when the user touches the liquid crystal display unit 201, the position of the hand is detected and position information thereof can be input. When the position information is input (YES in step S711), the processing proceeds to step S712.

In step S712, the control unit 105 determines a position and a size to display the confidential information display area 301 based on the input position information. A determination method will be described below.

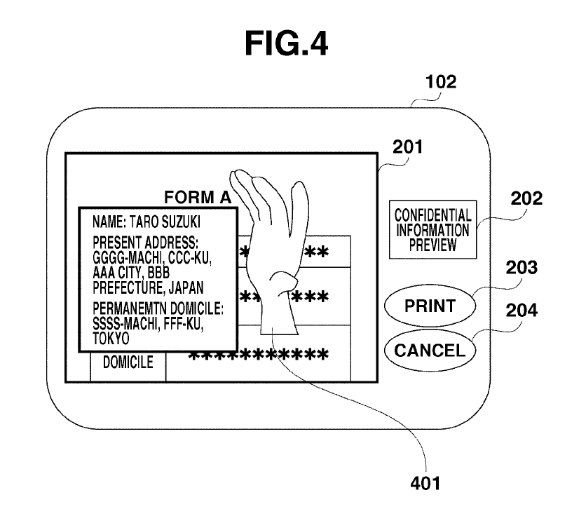

In step S713, the control unit 105 controls the operation unit 102 to display the confidential information display area 301 at the determined position and in the determined size. FIG. 4 illustrates an example of the confidential information display area displayed when the user puts a hand on the operation unit 102. A hand 401 is the user's hand. In FIG. 4, the confidential information display area 301 is displayed in a manner to be hidden by a palm along with a curve of fingers.

In step S714, the control unit 105 determines whether the print button 203 is pressed again. When the control unit 105 detects that the print button 203 is pressed again (YES in step S714), the processing advances to step S715. In step S715, the control unit 105 controls the printer unit 104 to perform printing based on the image data identified in step S702. If the print button 203 is not pressed again (NO in step S714), then in step S716, the control unit 105 determines whether the cancel button 204 is pressed. If the control unit 105 detects that the cancel button 204 is pressed (YES in step S716), the preview processing is terminated.

A method for calculating the position and the size of the confidential information display area 301 will be described below.

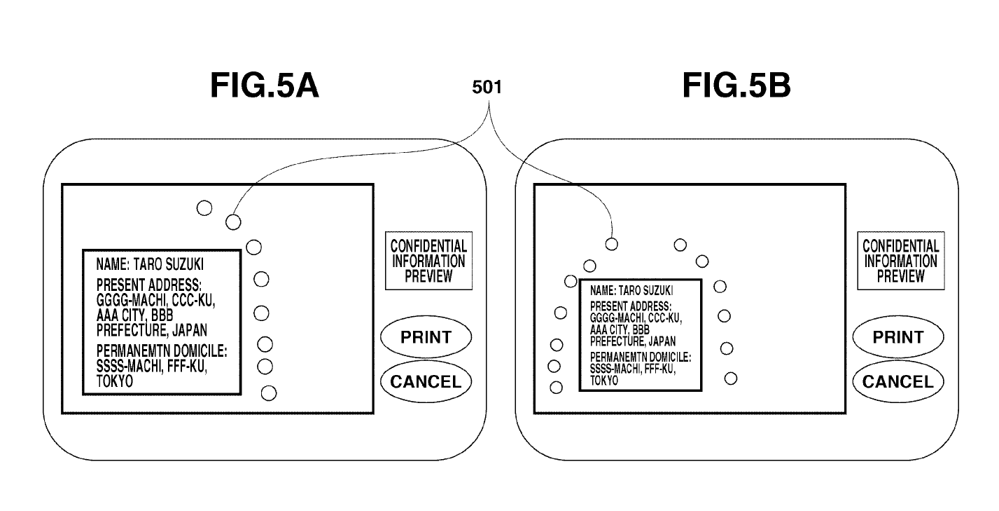

When the user puts a side of a hand on the liquid crystal display unit 201, the touch panel of the liquid crystal display unit 201 detects connecting points of the hand touching the panel, and transmits the position information of the hand to the control unit 105. FIGS. 5A and 5B are conceptual diagrams illustrating the relation between the connecting points 501 of the part of the hand(s) touching the panel and the position and the size of the confidential information display area. The connecting points 501 may be detected for one hand (FIG. 5A) or both hands (FIG. 5B). The position and the size of the confidential information display area 201 will be varied according to positions of the connecting points.

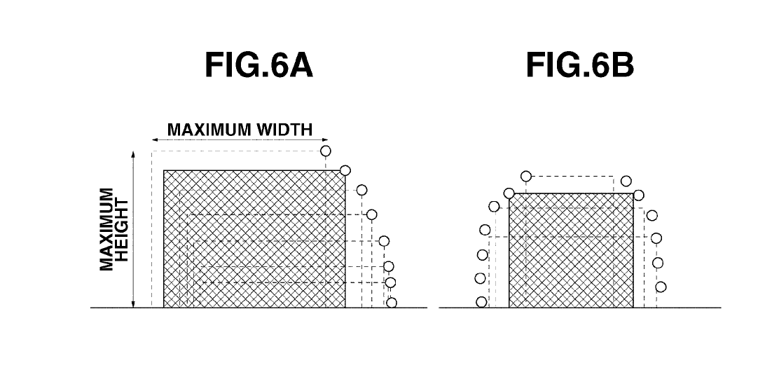

FIGS. 6A and 6B illustrate methods for calculating the position and the size of the confidential information display area 201 according to the positions of the connecting points.

A case where one hand is placed on the panel will be described referring to FIG. 6A.

Initially, in a first step minimum value among values of Y coordinate of the detected connecting points is taken as a value of the Y coordinate of a base of the confidential information display area based on the position information. In a second step, rectangles corresponding to the respective detected connecting points are all calculated as candidates for the confidential information display area. In this calculation, an upper limit value is set to each of a width and a height of the confidential information display area, and the width and the height of rectangle are set within these upper limit values. A base of each rectangle is aligned on the base of the confidential information display area. In FIG. 6A, seven calculated rectangles are illustrated as the example. Subsequently, in a third step, a rectangle which does not include any of the detected connecting points and has a largest area is selected from among the calculated rectangles. The position and the size of the selected rectangle are used as the position and the size of the confidential information display area. In the case the example in FIG. 6A, the position and the size of the rectangle with net-like pattern are used as the position and the size of the confidential information display area.

A case where both hands are placed on the panel will be described referring to FIG. 6B.

Initially, in a first step, the minimum value among values of the Y coordinate of the detected connecting points is taken as the value of the Y coordinate of the base of the confidential information display area based on the position information.

In a second step, rectangles corresponding to the respective detected connecting points are all calculated as candidates for the confidential information display area. In this calculation, the upper limit value is set to each of the width and the height of the confidential information display area, and the width and the height of rectangle are set within these upper limit values. Further, a rectangle is calculated so as not to include any of the detected connecting points. The base of each rectangle is aligned on the base of the confidential information display area. In FIG. 6B, four calculated rectangles are illustrated as the example.

Subsequently, in a third step, a rectangle which has a largest area is selected from among the calculated rectangles. The position and the size of the selected rectangle are used as the position and the size of the confidential information display area. In the case the example in FIG. 6B, the position and the size of the rectangle with net-like pattern are used as the position and the size of the confidential information display area.

As described above, the control unit 105 can calculate an optimum confidential information display area from detected connecting points, and confidential information is displayed in the area. Thus, the hand serves as a wall, and the confidential information can be displayed in a manner difficult for another person to peep.

Aspects of the present invention can also be realized by a computer of a system or apparatus (or devices such as a CPU, a micro-processor unit (MPU) and/or the like) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., a computer-readable storage medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

What is claimed is:

1. An information processing apparatus which controls a display unit, the information processing apparatus comprising:
a storage unit configured to store image data which represents an image, the image including specific information;
a first control unit configured to control the display unit to display an image represented by the image data so that the specific information is hidden; and
a second control unit configured to control the display unit to display the specific information in an area which is different from an area of the image in which the specific information is included, in response to an instruction to display the specific information.

2. The information processing apparatus according to claim 1, wherein the second control unit controls the display unit to display the specific information in response to pressing of a button to instruct display of the specific information.

3. The information processing apparatus according to claim 1, wherein the display unit is capable of detecting an input operation by a user, and
the second control unit controls the display unit to display the specific information in response to the input operation by the user detected by the display unit.

4. An information processing apparatus which controls a display unit capable of detecting an input operation of a user, the information processing apparatus comprising:
a determination unit configured to determine an area to display specific information according to a position where the input operation is detected by the display unit; and
a control unit configured to control the display unit to display the specific information in the area determined by the determination unit.

5. The information processing apparatus according to claim 4, wherein the display unit is capable of detecting a position where a user's hand contacts and the determination unit determines an area to display the specific information according to the position where the user's hand contacts.

6. The information processing apparatus according to claim 4, wherein the determination unit determines an area to display the specific information according to a plurality of positions where the input operation is detected by the display unit.

7. The information processing apparatus according to claim 6, wherein the determination unit determines a plurality of candidate areas to display the specific information according to the plurality of positions where the input operation is detected by the display unit, and determines the largest one of the plurality of the candidate areas as the area to display the specific information.

8. A method for controlling display executed in an information processing apparatus which controls a display unit, the method comprising:
controlling, based on image data which represents an image including specific information, the display unit to display an image represented by the image data so that the specific information is hidden; and
controlling the display unit to display the specific information in an area which is different from an area of the image in which the specific information is included, in response to an instruction to display the specific information.

9. A method for controlling display executed in an information processing apparatus which controls a display unit capable of detecting an input operation of a user, the method comprising:
determining an area to display specific information according to a position where the input operation is detected by the display unit; and
controlling the display unit to display the specific information in the determined area.

10. A computer-readable storage medium for causing a computer to execute the method according to claim 8.

11. A computer-readable storage medium for causing a computer to execute the method according to claim 9.
